(19) United States
(12) Patent Application Publication
(10) Pub. No.: US 2021/0284142 A1
(43) Pub. Date: Sep. 16, 2021

(54) CONTROL DEVICE AND VEHICLE

(71) Applicant: HONDA MOTOR CO., LTD., Tokyo (JP)

(72) Inventors: Takashi Mine, Wako-shi (JP); Yuki Kizumi, Wako-shi (JP); Keisuke Oka, Wako-shi (JP); Masahiko Asakura, Tokyo (JP)

(21) Appl. No.: 17/181,178

(22) Filed: Feb. 22, 2021

(30) Foreign Application Priority Data
Mar. 12, 2020 (JP) 2020-043258

(51) Int. Cl. B60W 30/09; G08G 1/16; B60W 30/095; B60W 30/14; G06K 9/00

(52) U.S. Cl. CPC B60W 30/09; G08G 1/167; B60W 30/0956; B60W 30/143; G06K 9/00825; B60W 2420/52; B60W 2554/802; B60W 2520/10; B60W 2554/801; B60W 2554/4045; B60W 2420/42; G06K 9/00798

(57) ABSTRACT

The present invention provides a control device including a recognizing unit that recognizes another vehicle present in an adjacent lane adjacent to a travel lane in which a self-vehicle travels, a determining unit that, on the basis of behavior of the other vehicle recognized by the recognizing unit and a determination standard set with respect to the behavior, determines whether or not the other vehicle will change lanes into the travel lane of the self-vehicle, and a controller that, in accordance with a result of the determination by the determining unit as to whether or not the other vehicle will change lanes, controls travel of the self-vehicle, wherein the determining unit changes the determination standard in accordance with a distance between the self-vehicle and the other vehicle in a travel direction of the self-vehicle.

### CROSS-REFERENCE TO RELATED APPLICATION(S)

This application claims priority to and the benefit of Japanese Patent Application No. 2020-043258 filed on Mar. 12, 2020, the entire disclosure of which is incorporated herein by reference.

### BACKGROUND OF THE INVENTION

### Field of the Invention

The present invention relates to a control device that controls travel of a vehicle, and to a vehicle.

### Description of the Related Art

In vehicles such as four-wheeled vehicles, a function called adaptive cruise control (ACC), in which a self-vehicle follows a forward vehicle while maintaining an appropriate inter-vehicle distance between the self-vehicle and the forward vehicle, is known as a driving assistance technology that lightens the driving load on a driver. In ACC, when the self-vehicle approaches the forward vehicle, a distance, speed difference, and the like between the self-vehicle and the forward vehicle are measured, and the acceleration/deceleration of the self-vehicle is controlled automatically. Additionally, in ACC, when another vehicle cuts into the area between the host vehicle and the forward vehicle (changes lanes), the vehicle to be followed automatically switches so that the self-vehicle follows that other vehicle.

In recent years, a great amount of energy is being devoted to the development and research of technologies related to ACC. For example, Japanese Patent Laid-Open No. 2019-55675 discloses a technique that prevents unnecessary acceleration/deceleration in a self-vehicle by determining whether or not another vehicle traveling in an adjacent lane adjacent to the lane in which the self-vehicle is traveling will change lanes (cut in) on the basis of the behavior of the other vehicle, and controlling the travel of the self-vehicle in accordance with that determination. According to this technique, whether or not the other vehicle will change lanes is determined on the basis of a travel attitude of the other vehicle, a change in the travel attitude over time, whether or not a directional indicator is blinking, a relative position of the other vehicle with respect to the self-vehicle, an amount of change in the stated relative position, and the like.

However, the technique disclosed in Japanese Patent Laid-Open No. 2019-55675 does not take into account erratic movement in the other vehicle traveling in the adjacent lane adjacent to the lane in which the self-vehicle is traveling. Accordingly, when determining whether or not another vehicle traveling in an adjacent lane is going to change lanes on the basis of the behavior of that other vehicle, there is a possibility that the other vehicle will be determined (mistakenly) to be changing lanes due to mere erratic movement of the other vehicle. Such mistaken determinations can lead to excessive deceleration control in the self-vehicle.

### SUMMARY OF THE INVENTION

The present invention provides a novel technique useful for determining whether or not another vehicle present in an adjacent lane adjacent to a lane in which a self-vehicle is traveling will change lanes.

According to one aspect of the present invention, there is provided a control device that controls travel of a vehicle, the control device including a recognizing unit that recognizes another vehicle present in an adjacent lane adjacent to a travel lane in which a self-vehicle travels, a determining unit that, on the basis of behavior of the other vehicle recognized by the recognizing unit and a determination standard set with respect to the behavior, determines whether or not the other vehicle will change lanes into the travel lane of the self-vehicle, and a controller that, in accordance with a result of the determination by the determining unit as to whether or not the other vehicle will change lanes, controls travel of the self-vehicle, wherein the determining unit changes the determination standard in accordance with a distance between the self-vehicle and the other vehicle in a travel direction of the self-vehicle.

Further objects or other aspects of the present invention will be made apparent by the embodiments described below with reference to the accompanying drawings.

### BRIEF DESCRIPTION OF THE DRAWINGS

FIG. 1 is a block diagram illustrating the configuration of a control device according to one aspect of the present invention.

FIG. 2 is a diagram illustrating an example of an issue in technology pertaining to ACC.

FIG. 3 is a diagram illustrating processing of determining a lane change made by another vehicle according to an embodiment.

FIGS. 4A and 4B are diagrams illustrating processing of determining a lane change made by another vehicle according to an embodiment.

FIGS. 5A and 5B are diagrams illustrating processing of determining a lane change made by another vehicle according to an embodiment.

FIG. 6 is a diagram illustrating processing of determining a lane change made by another vehicle according to an embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

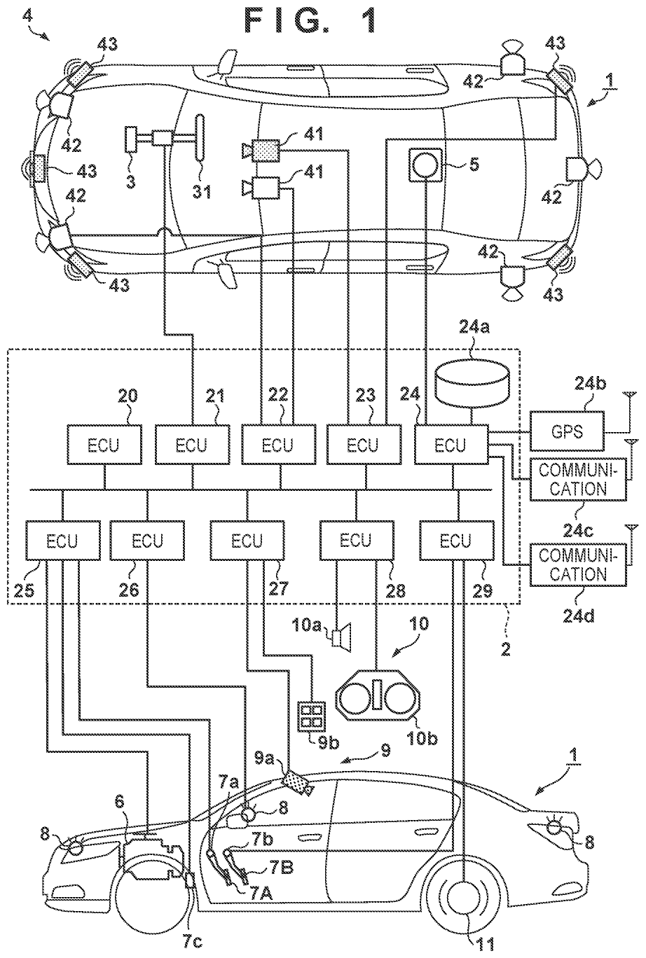

FIG. 1 is a block diagram illustrating the configuration of a control device according to one aspect of the present invention. The control device illustrated in FIG. 1 is a device that controls the travel of a vehicle 1, and in the present embodiment, controls automated driving of the vehicle 1. An overview of the vehicle 1 is illustrated in FIG. 1, both as a plan view and as a side view. The vehicle 1 is, for example, a sedan-type four-wheeled passenger vehicle (a four-wheeled vehicle).

The control device illustrated in FIG. 1 includes a control unit 2 (a controller). The control unit 2 includes a plurality of ECUs 20 to 29, which are communicatively connected over an in-vehicle network. Each of the ECUs 20 to 29 includes a processor such as a CPU, a storage device such as semiconductor memory, an interface with external devices, and the like. The storage device stores programs executed by the processor, the data used in processing by the processor, and so on. Each of the ECUs 20 to 29 may include a plurality of processors, storage devices, interfaces, and the like.

Functions and the like handled by each of the ECUs 20 to 29 will be described hereinafter. Note that the number of ECUs, the functions handled by the ECUs, and so on can be designed as appropriate, and can be set at a finer or broader level than that described in the present embodiment.

The ECU 20 executes control pertaining to the automated driving of the vehicle 1. During automated driving, at least one of the steering and the acceleration/deceleration of the vehicle 1 is automatically controlled. As will be described later, in the present embodiment, the ECU 20 automatically controls both steering and acceleration/deceleration.

The ECU 21 controls an electric power steering device 3. The electric power steering device 3 includes a mechanism for turning the front wheels in response to a driver making a driving operation (turning operation) on a steering wheel 31. The electric power steering device 3 also includes a motor for assisting the turning operation or for producing drive power for automatically turning the front wheels, a sensor for detecting a steering angle, and the like. When the driving state of the vehicle 1 is automated driving, the travel direction of the vehicle 1 is controlled by the ECU 21 automatically controlling the electric power steering device 3 in accordance with instructions from the ECU 20.

The ECUs 22 and 23 control detecting units 41 to 43, which detect the surrounding conditions of the vehicle 1, and process information of detection results. The detecting unit 41 is a camera that captures an image to the front of the vehicle 1 (this may be referred to as a “camera 41” hereinafter). In the present embodiment, two cameras 41 are provided on a front part of the roof of the vehicle 1. By analyzing the images captured by the cameras 41, the contours of objects can be extracted, lane dividing lines on the road (e.g., white lines) and the like can be extracted, and so on. Through this, the ECUs 22 and 23 can detect pedestrians, other vehicles, and the like, and more specifically, can recognize pedestrians to the front, the type of other vehicles (forward vehicles) (heavy vehicle, standard-size vehicle, and the like), road information (sidewalks, shoulders, travel paths, and the like), and obstructions on the road.

The detecting unit 42 is LIDAR (Light Detection and Ranging) (e.g., laser radar; this may be referred to as “LIDAR 42” hereinafter). The LIDAR 42 detects objects in the periphery of the vehicle 1, measures the distances to those objects, and the like. In the present embodiment, five of the LIDAR 42 are provided: one on each front corner of the vehicle 1, one in the rear center, and one each on the rear sides of the vehicle 1. The detecting unit 43 is millimeter wave radar (this may be referred to as “radar 43” hereinafter). The radar 43 detects objects in the periphery of the vehicle 1, measures the distances to those objects, and the like. In the present embodiment, five of the radar 43 are provided: one in the front-center of the vehicle 1, as well as one each on the front and rear corners of the vehicle 1.

The ECU 22 controls one of the cameras 41 and each LIDAR 42, and processes information of the detection results therefrom. The ECU 23 controls the other of the cameras 41 and each radar 43, and processes information of the detection results therefrom. By providing two sets of devices that detect the surrounding conditions of the vehicle 1 in this manner, the reliability of the detection results is improved; furthermore, by providing different types of detecting units, i.e., cameras, LIDAR, and radar, the peripheral environment of the vehicle can be analyzed in several different ways. Additionally, on the basis of the distances to objects in the periphery of the vehicle 1 measured by the LIDAR 42 and the radar 43, the ECUs 22 and 23 can detect a relative speed between the vehicle 1 and the objects; and furthermore, on the basis of absolute speed information of the vehicle 1, the absolute speeds of the objects in the periphery of the vehicle 1 can also be detected.

The ECU 24 controls a gyrosensor 5, a GPS sensor 24b, and a communication device 24c, and processes information of detection results or communication results therefrom. The gyrosensor 5 detects rotational movement of the vehicle 1. The path of the vehicle 1 can be determined from the detection results from the gyrosensor 5, the wheel speed, and so on. The GPS sensor 24b detects the current position of the vehicle 1. The communication device 24c communicates wirelessly with a server that provides map information, traffic information, and the like, and obtains that information. The ECU 24 can access a map information database 24a provided in the storage device, and searches for routes from the current location to a destination and the like. The ECU 24 also includes a communication device 24d for vehicle-to-vehicle communication. The communication device 24d communicates wirelessly with other vehicles in the periphery, and exchanges information with those vehicles.

The ECU 25 controls a power plant 6. The power plant 6 is a mechanism for outputting drive power that rotates drive wheels of the vehicle 1, and includes an engine and a transmission, for example. For example, the ECU 25 controls the output of the engine in response to a driving operation (an acceleration operation) made by the driver, detected by an operation detection sensor 7a provided in an accelerator pedal 7A, switches the gear range of the transmission on the basis of information such as the vehicle speed detected by a vehicle speed sensor 7c, and the like. When the driving state of the vehicle 1 is automated driving, the ECU 25 automatically controls the power plant 6 in response to instructions from the ECU 20, and controls the acceleration/deceleration of the vehicle 1.

The ECU 26 controls lights (headlights, taillights, and the like), including directional indicators 8 (blinkers). In the present embodiment, the directional indicators 8 are provided at the front of the vehicle 1, in side mirrors, and at the rear of the vehicle 1.

The ECU 27 controls a detecting unit 9, which detects conditions within the vehicle, and processes information of detection results. In the present embodiment, a camera 9a that captures an image of the vehicle interior and an input device 9b that accepts the input of information from an occupant in the vehicle are provided as the detecting unit 9. In the present embodiment, the camera 9a is provided in a front part of the roof of the vehicle 1, and captures an image of an occupant in the vehicle (e.g., the driver). The input device 9b is disposed in a position where the device can be operated by an occupant in the vehicle, and is a group of switches for making instructions to the vehicle 1.

The ECU 28 controls an output device 10. The output device 10 outputs information to the driver and accepts the input of information from the driver. An audio output device 10a communicates information to the driver through audio. A display device 10b communicates information to the driver by displaying images. The display device 10b is disposed, for example, in front of the driver's seat, and constitutes an instrument panel and the like, for example. Although audio and a display are mentioned in the present embodiment as examples, information may be communicated through vibrations, lights, or the like. The information may also be communicated using a combination of audio, a display, vibrations, and lights.

The ECU 29 controls a braking device 11, a parking brake (not shown), and the like. The braking device 11 is, for example, a disk brake device, provided in each of the wheels of the vehicle 1, which causes the vehicle 1 to decelerate or stop by applying resistance against the rotation of the wheels. The ECU 29 controls the operations of the braking device 11 in response to a driving operation (a braking operation) made by the driver, detected by an operation detection sensor 7b provided in a brake pedal 7B, for example. If the driving state of the vehicle 1 is automated driving, the ECU 29 controls the deceleration and stopping of the vehicle 1 by automatically controlling the braking device 11 in response to instructions from the ECU 20. The braking device 11, the parking brake, and the like can also be operated in order to keep the vehicle 1 in a stopped state. Furthermore, if the transmission of the power plant 6 is provided with a parking lock function, that parking lock function can also be operated in order to keep the vehicle 1 in a stopped state.

According to the vehicle 1 configured in this manner, automated driving is provided as driving assistance technology that lightens the driving load on the driver. In the present embodiment, adaptive cruise control (ACC), in which a self-vehicle (the vehicle 1) follows a forward vehicle while maintaining an appropriate inter-vehicle distance between the self-vehicle and the forward vehicle, is provided as automated driving. In ACC, when the self-vehicle approaches the forward vehicle, the ECU 20 automatically controls the acceleration/deceleration of the self-vehicle so that the self-vehicle follows the forward vehicle. Here, the “forward vehicle” is a vehicle present in front in the travel lane in which the self-vehicle travels, i.e., a vehicle traveling in front of the self-vehicle in the same lane.

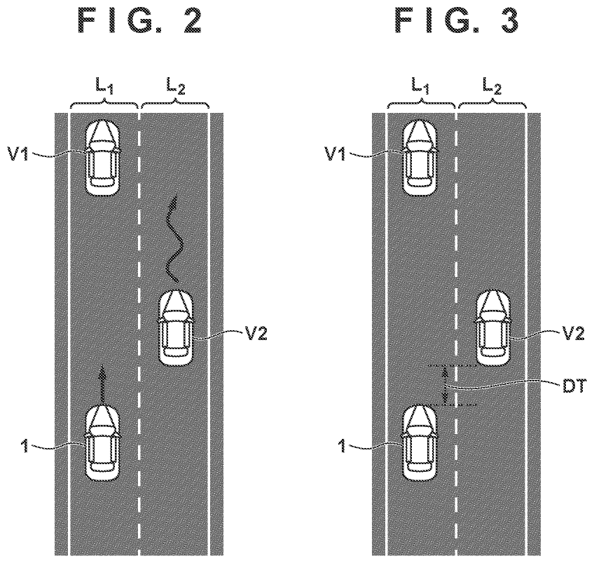

However, there are issues in ACC-related technologies which should be improved. For example, in addition to the self-vehicle and the forward vehicle, there are also vehicles present in adjacent lanes adjacent to the travel lane in which the self-vehicle travels, i.e., vehicles traveling in the adjacent lane (these will be called “other vehicles” hereinafter). As such, it is necessary to control the acceleration/deceleration of the self-vehicle taking into account the travel of other vehicles as well, and thus in past techniques, whether or not another vehicle will change lanes (whether or not the other vehicle will cut in between the self-vehicle and the forward vehicle) is determined from the other vehicle's behavior. However, as illustrated in FIG. 2, when the self-vehicle 1 is traveling in a first lane L₁ (the travel lane) so as to follow a forward vehicle V1, another vehicle V2 traveling in a second lane L₂ (an adjacent lane) adjacent to the first lane L₁ may be moving erratically in a vehicle width direction. In such a case, the other vehicle V2 behaves as if it is approaching the first lane L₁, and thus with past techniques, it is determined (mistakenly) that the other vehicle V2 will change lanes from the behavior (erratic movement) of the other vehicle V2, which can cause excessive deceleration control in the self-vehicle 1.

Accordingly, in the present embodiment, in a situation such as that illustrated in FIG. 2, the ECU 20 determines whether or not the other vehicle V2 will change lanes into the travel lane in which the self-vehicle 1 travels (the first lane L₁) on the basis of the behavior of the other vehicle V2 and a determination standard set with respect to the behavior of the other vehicle V2, and controls the travel (acceleration/deceleration) of the self-vehicle 1 in accordance with a result of the determination. At this time, as illustrated in FIG. 3, the determination standard is changed in accordance with a distance DT between the self-vehicle 1 and the other vehicle V2 in the travel direction of the self-vehicle 1. In this manner, by changing the determination standard in accordance with the distance DT between the self-vehicle 1 and the other vehicle V2, e.g., by relaxing the determination standard for determining that the other vehicle V2 will change lanes as the distance DT increases, mistaken determinations (that the other vehicle V2 will change lanes) made in response to erratic movement of the other vehicle V2 can be suppressed, and whether the other vehicle V2 will change lanes can be determined appropriately in accordance with the distance DT. Although the distance DT between the self-vehicle 1 and the other vehicle V2 is defined as a distance between a front end part of the self-vehicle 1 and a rear end part of the other vehicle V2 in FIG. 3, the distance DT is not limited thereto. For example, the distance DT between the self-vehicle 1 and the other vehicle V2 may be defined as a distance between a center of gravity of the self-vehicle 1 and a center of gravity of the other vehicle V2. Additionally, the determination standard for determining that the other vehicle V2 will change lanes is set so that it can be determined whether or not the other vehicle V2 will change lanes even when the distance DT between the self-vehicle 1 and the other vehicle V2 is great, i.e., for another vehicle V2 located far away.

Determination processing executed by the ECU 20 according to the present embodiment, i.e., processing for determining whether or not the other vehicle V2 will change lanes, will be described next. This processing is performed by the ECU 20 comprehensively controlling the respective units of the vehicle 1 and the control device (FIG. 1). It is assumed here that ACC is performed so that the self-vehicle 1 follows the forward vehicle V1, that the travel lane in which the self-vehicle 1 travels is the first lane L₁, and the adjacent lane adjacent to the first lane L₁ is the second lane L₂.

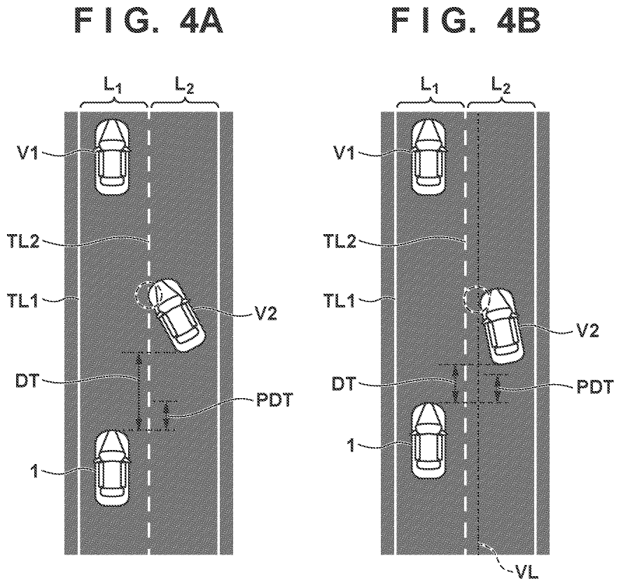

As illustrated in FIG. 4A, when the distance DT between the self-vehicle 1 and the other vehicle V2 is greater than or equal to a predetermined distance PDT, the ECU 20 determines that the other vehicle V2 will change lanes at the point in time when at least part of the other vehicle V2 crosses a line TL2 which, of lines TL1 and TL2 defining the first lane L₁, is on the second lane L₂ side. On the other hand, as illustrated in FIG. 4B, when the distance DT between the self-vehicle 1 and the other vehicle V2 is less than the predetermined distance PDT, it is determined that the other vehicle V2 will change lanes at the point in time when the other vehicle V2 has crossed a virtual line VL set within the second lane (on an inner side of the second lane L₂). In this manner, when the distance DT between the self-vehicle 1 and the other vehicle V2 is great, there is little need to quickly cause the self-vehicle 1 to decelerate even if the other vehicle V2 changes lanes, and thus using the line TL2 as the determination standard for determining that the other vehicle V2 will change lanes (relaxing the determination standard) makes it possible to suppress situations where erratic movement of the other vehicle V2 is mistakenly determined to be a lane change. On the other hand, when the distance DT between the self-vehicle 1 and the other vehicle V2 is small, there is a greater need to quickly cause the self-vehicle 1 to decelerate when the other vehicle V2 changes lanes, and thus using the virtual line VL as the determination standard for determining that the other vehicle V2 will change lanes (tightening the determination standard) makes it possible to prioritize making the determination that the other vehicle V2 will change lanes early. Accordingly, the determination that the other vehicle V2 will change lanes can be made appropriately in accordance with the distance DT between the self-vehicle 1 and the other vehicle V2.

Although the present embodiment describes a case in which the determination standard for determining that the other vehicle V2 will change lanes is set to the line TL2 or the virtual line VL in accordance with the distance DT between the self-vehicle 1 and the other vehicle V2 as illustrated in FIGS. 4A and 4B, the configuration is not limited thereto. It is sufficient to relax the determination standard for determining that the other vehicle V2 will change lanes as the distance DT between the self-vehicle 1 and the other vehicle V2 increases, and tighten the determination standard for determining that the other vehicle V2 will change lanes as the distance DT between the self-vehicle 1 and the other vehicle V2 decreases. For example, the determination standard may be set as an amount of offset with respect to the center of the second lane L₂. Additionally, the virtual line VL set within the second lane may be variable with respect to the distance DT between the self-vehicle 1 and the other vehicle V2. For example, the virtual line VL may be set to shift away from the line TL2 as the distance DT (<PDT) between the self-vehicle 1 and the other vehicle V2 decreases.

Additionally, the vehicle 1 is provided with the vehicle speed sensor 7c as an obtaining unit that obtains the travel speed of the self-vehicle. Accordingly, the ECU 20 may change the determination standard for determining that the other vehicle V2 will change lanes in accordance with the travel speed of the self-vehicle 1 obtained by the vehicle speed sensor 7c. Generally speaking, there is a greater need to quickly cause the self-vehicle 1 to decelerate when the other vehicle V2 changes lanes if the self-vehicle 1 is traveling at a higher travel speed, whereas there is less need to quickly cause the self-vehicle 1 to decelerate when the other vehicle V2 changes lanes if the self-vehicle 1 is traveling at a lower travel speed. Accordingly, the determination standard for determining that the other vehicle V2 will change lanes is changed so that it is easier to determine that the other vehicle V2 will change lanes when the travel speed of the self-vehicle 1 is higher than when the travel speed of the self-vehicle 1 is lower. Specifically, when the travel speed of the self-vehicle 1 is high, the virtual line VL is used as the determination standard for determining that the other vehicle V2 will change lanes (the determination standard is tightened), as illustrated in FIG. 4B, and when the travel speed of the self-vehicle 1 is low, the line TL2 is used as the determination standard for determining that the other vehicle V2 will change lanes (the determination standard is relaxed), as illustrated in FIG. 4A. Through this, when the travel speed of the vehicle 1 is low, the suppression of mistakenly determining erratic movement of the other vehicle V2 to be a lane change is prioritized, whereas when the travel speed of the self-vehicle 1 is high, the early determination that the other vehicle V2 will change lanes is prioritized, which makes it possible to determine that the other vehicle V2 will change lanes appropriately in accordance with the travel speed of the self-vehicle 1.

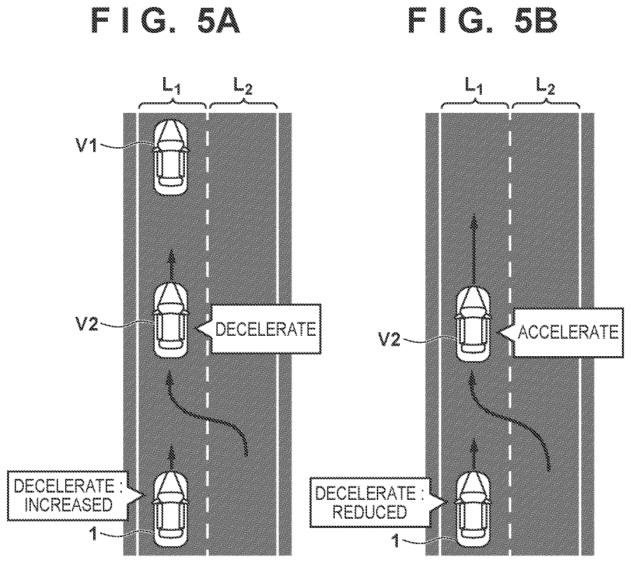

Additionally, although the present embodiment assumes a state in which following travel control that causes the self-vehicle 1 to follow the travel of the forward vehicle V1 is being performed, i.e., that ACC is being performed, there are cases where even if ACC is not being performed, it is necessary to perform deceleration control to cause the self-vehicle 1 to decelerate in order to avoid a collision with the other vehicle when it is determined that the other vehicle V2 will change lanes. At this time, as described above, the extent to which the self-vehicle 1 is caused to decelerate in the deceleration control may be changed in accordance with whether or not the forward vehicle V1 has been recognized by the detecting units 41 to 43, which function as a recognizing unit that recognizes (detects) the other vehicle V2. For example, as illustrated in FIG. 5A, when the forward vehicle V1 is recognized, it is possible that another vehicle V2 which has changed lanes (cut into the lane) between the forward vehicle V1 and the self-vehicle 1 will decelerate according to the traveling of the forward vehicle V1, and thus the extent to which the self-vehicle 1 is caused to decelerate is increased in the deceleration control. On the other hand, as illustrated in FIG. 5B, when the forward vehicle V1 is not recognized, it is unlikely that the other vehicle V2 which has changed lanes in front of the self-vehicle 1 will decelerate, and thus the extent to which the self-vehicle 1 is caused to decelerate is reduced in the deceleration control. Accordingly, deceleration control for causing the self-vehicle 1 to decelerate can be performed appropriately in accordance with whether or not the forward vehicle V1 is present.

Note that when the forward vehicle V1 has not been recognized by the detecting units 41 to 43, the extent to which the self-vehicle 1 is caused to decelerate in the deceleration control may be set to zero, so that the self-vehicle 1 does not decelerate. When there is no forward vehicle V1, it is conceivable that the other vehicle V2 will accelerate and change lanes at a higher travel speed than the self-vehicle 1. It is therefore not necessary to cause the self-vehicle 1 to decelerate, and thus by setting the extent to which the self-vehicle 1 is caused to decelerate to zero, excessive deceleration control of the self-vehicle 1 can be suppressed.

Additionally, the ECU 20 may determine whether or not the other vehicle V2 is moving erratically on the basis of the behavior of the other vehicle V2. For example, a threshold (a determination standard for erratic movement) can be set to a position further from the line TL2 than the virtual line VL (or the lane L₂), and the other vehicle V2 can be determined to be moving erratically when the other vehicle V2 moves across that threshold in the vehicle width direction. It is also possible to determine that the other vehicle V2 is moving erratically when the other vehicle V2 moves across the above-described threshold no less than a predetermined number of times within a predetermined amount of time. Accordingly, the determination standard for determining that the other vehicle V2 will change lanes may be changed so that it is more difficult to determine that the other vehicle V2 will change lanes when it is determined that the other vehicle V2 is moving erratically than when it is determined that the other vehicle V2 is not moving erratically. Specifically, when it is determined that the other vehicle V2 is moving erratically, the determination standard for determining that the other vehicle V2 will change lanes is set to the line TL2 (the determination standard is relaxed), as illustrated in FIG. 4A, whereas when it is determined that the other vehicle V2 is not moving erratically, the determination standard for determining that the other vehicle V2 will change lanes is set to the virtual line VL (the determination standard is tightened), as illustrated in FIG. 4B. This makes it possible to suppress situations where erratic movement of the other vehicle V2 is mistakenly determined as a lane change, and suppress excessive deceleration control with respect to erratic movement in the other vehicle V2.

Additionally, the ECU 20 may change the determination standard for determining that the other vehicle V2 will change lanes in accordance with an amount of time for which the other vehicle V2 is moving erratically. For example, the determination standard for determining that the other vehicle V2 will change lanes is changed so that it is more difficult to determine that the other vehicle V2 will change lanes when the amount of time for which the other vehicle V2 is determined to be moving erratically is long than when the amount of time for which the other vehicle V2 is determined to be moving erratically is short. Specifically, when the time for which the other vehicle V2 is determined to be moving erratically is long, the determination standard for determining that the other vehicle V2 will change lanes is set to the line TL2 (the determination standard is relaxed), as illustrated in FIG. 4A, whereas when the time for which the other vehicle V2 is determined to be moving erratically is short, the determination standard for determining that the other vehicle V2 will change lanes is set to the virtual line VL (the determination standard is tightened), as illustrated in FIG. 4B. In this manner, by making it more difficult to determine that the other vehicle V2 will change lanes when erratic movement of the other vehicle V2 is short (initially) and making it easier to determine that the other vehicle V2 will change lanes when erratic movement of the other vehicle V2 is long, excessive deceleration control of the self-vehicle 1 with respect to what is clearly erratic movement of the other vehicle V2 can be suppressed.

Additionally, the ECU 20 may change the determination standard for determining that the other vehicle V2 will change lanes so that it is easier to determine that the other vehicle V2 will change lanes when the amount of time for which it is determined that the other vehicle V2 is moving erratically is short than when the amount of time for which it is determined that the other vehicle V2 is moving erratically is long, and may change the determination standard for determining that the other vehicle V2 will change lanes so that it is more difficult to determine that the other vehicle V2 will change lanes when the amount of time for which it is determined that the other vehicle V2 is moving erratically is long than when it is determined that the other vehicle V2 is not moving erratically.

H1193626US01/P220-0944US

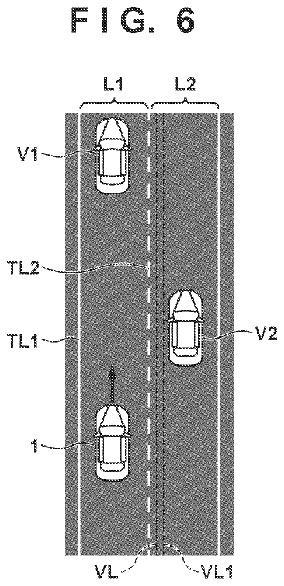

Specifically, as illustrated in FIG. 6, assuming that the virtual line VL is used as the determination standard for determining that the other vehicle V2 will change lanes when it is determined that the other vehicle V2 is not moving erratically, the determination standard for determining that the other vehicle V2 will change lanes is set to a virtual line VL1 further from the line TL2 than the virtual line VL (or the lane L2) (the determination standard is tightened) when the time for which it is determined that the other vehicle V2 is moving erratically is short, and the determination standard for determining that the other vehicle V2 will change lanes is set to the line TL2 (the determination standard is relaxed) when the time for which it is determined that the other vehicle V2 is moving erratically is long. This makes it possible to suppress excessive deceleration control of the self-vehicle 1 with respect to what is clearly erratic movement of the other vehicle V2.

Additionally, the ECU 20 may change the determination standard for determining that the other vehicle V2 will change lanes in accordance with an extent (frequency) of erratic movement of the other vehicle V2. Here, the “extent” of erratic movement of the other vehicle V2 includes an absolute value of an amount of movement of the other vehicle V2 in the vehicle width direction, a number of times the other vehicle V2 moves in the vehicle width direction, a speed at which the other vehicle V2 moves in the vehicle width direction when crossing a threshold set at a position further from the line TL2 than the virtual line VL, and so on. For example, the determination standard for determining that the other vehicle V2 will change lanes is changed so that it is easier to determine that the other vehicle V2 will change lanes when the extent of erratic movement in the other vehicle V2 is greater than a threshold. Specifically, the line TL2 is used as the determination standard for determining that the other vehicle V2 will change lanes (the determination standard is relaxed) when the extent of erratic movement in the other vehicle V2 is greater than the threshold, as illustrated in FIG. 4A, and the virtual line VL is used as the determination standard for determining that the other vehicle V2 will change lanes (the determination standard is tightened) when the extent of erratic movement in the other vehicle V2 is less than or equal to the threshold, as illustrated in FIG. 4B. Generally speaking, it is thought that as the extent of erratic movement in the other vehicle V2 increases, the other vehicle V2 is more likely to enter into the lane in which the self-vehicle 1 is traveling, and it is therefore necessary to perform deceleration control that causes the self-vehicle 1 to decelerate. Accordingly, deceleration control that causes the self-vehicle 1 to decelerate can be performed by making it easier to determine that the other vehicle V2 will change lanes as the extent of erratic movement in the other vehicle V2 increases. Note that when the number of times the other vehicle V2 moves in the vehicle width direction is used as the extent of erratic movement, a standard for determining the above-described erratic movement, i.e., a number of times the other vehicle V2 crosses a position further from the line TL2 than the virtual line VL being greater than a predetermined number of times within a predetermined amount of time, may be set as the standard (threshold) for determining the extent of erratic movement.

### Summary of Embodiments

1. A control device according to the foregoing embodiment is a control device (e.g., 2) that controls travel of a vehicle (e.g., 1), the control device including:

a recognizing unit (e.g., 41, 42, 43) that recognizes another vehicle (e.g., V2) present in an adjacent lane (e.g., L₂) adjacent to a travel lane (e.g., L₁) in which a self-vehicle (e.g., 1) travels;

a determining unit (e.g., 20) that, on the basis of behavior of the other vehicle recognized by the recognizing unit and a determination standard set with respect to the behavior, determines whether or not the other vehicle will change lanes into the travel lane of the self-vehicle; and

a controller (e.g., 20) that, in accordance with a result of the determination by the determining unit as to whether or not the other vehicle will change lanes, controls travel of the self-vehicle,

wherein the determining unit changes the determination standard in accordance with a distance (e.g., DT) between the self-vehicle and the other vehicle in a travel direction of the self-vehicle.

According to this embodiment, mistaken determinations (that the other vehicle will change lanes) with respect to erratic movement of the other vehicle can be suppressed, and the determination that the other vehicle will change lanes can be made appropriately in accordance with the distance between the self-vehicle and the other vehicle.

2. In the control device (e.g., 2) according to the foregoing embodiment, when the distance (e.g., DT) is greater than or equal to a predetermined distance (e.g., PDT), the determining unit (e.g., 20) determines that the other vehicle (e.g., V2) will change lanes at a point in time when at least part of the other vehicle has crossed a line (e.g., TL2), of lines (e.g., TL1, TL2) defining the travel lane (e.g., L₁), which is located on the adjacent lane side, and when the distance is less than the predetermined distance, the determining unit changes the determination standard so as to determine that the other vehicle will change lanes at a point in time when at least part of the other vehicle crosses a virtual line (e.g., VL) set within the adjacent lane.

According to this embodiment, the determination that the other vehicle will change lanes can be made appropriately in accordance with the distance between the self-vehicle and the other vehicle.

3. The control device (e.g., 2) according to the foregoing embodiment further includes an obtaining unit (e.g., 7c) that obtains a travel speed of the self-vehicle (e.g., 1).

Here, the determining unit (e.g., 20):

changes the determination standard in accordance with the travel speed of the self-vehicle obtained by the obtaining unit, and

changes the determination standard so that it is easier to determine that the other vehicle (e.g., V2) will change lanes when the travel speed of the self-vehicle is high than when the travel speed of the self-vehicle is low.

According to this embodiment, the determination that the other vehicle will change lanes can be made appropriately in accordance with the travel speed of the self-vehicle.

4. In the control device (e.g., 2) according to the foregoing embodiment,

when the determining unit (e.g., 20) has determined that the other vehicle (e.g., V2) will change lanes, the controller (e.g., 20) performs deceleration control that causes the self-vehicle (e.g., 1) to decelerate.

According to this embodiment, a collision with the other vehicle can be avoided.

5. In the control device (e.g., 2) according to the foregoing embodiment,

the recognizing unit (e.g., 41, 42, 43) recognizes a forward vehicle (e.g., V1) present in front in the travel lane (e.g., L₁) in which the self-vehicle (e.g., 1) travels, and

the controller (e.g., 20) changes the extent to which the self-vehicle is caused to decelerate in the deceleration control in accordance with whether or not the forward vehicle has been recognized by the recognizing unit.

According to this embodiment, deceleration control for causing the self-vehicle to decelerate can be performed appropriately in accordance with whether or not the forward vehicle is present.

6. In the control device (e.g., 2) according to the foregoing embodiment,

the controller (e.g., 20) sets the extent to which the self-vehicle (e.g., 1) is caused to decelerate in the deceleration control to zero when the forward vehicle (e.g., V1) is not recognized by the recognizing unit (e.g., 41, 42, 43).

According to this embodiment, excessive deceleration control in the self-vehicle can be suppressed.

7. In the control device (e.g., 2) according to the foregoing embodiment,

the determining unit (e.g., 20):

determines whether or not the other vehicle (e.g., V2) is moving erratically in a vehicle width direction on the basis of the behavior of the other vehicle, and

changes the determination standard so that it is more difficult to determine that the other vehicle will change lanes when it is determined that the other vehicle is moving erratically in the vehicle width direction than when it is determined that the other vehicle is not moving erratically in the vehicle width direction.

According to this embodiment, excessive deceleration control in the self-vehicle with respect to another vehicle that is moving erratically can be suppressed.

8. In the control device (e.g., 2) according to the foregoing embodiment,

the determining unit (e.g., 20):

changes the determination standard in accordance with a time for which it is determined that the other vehicle (e.g., V2) is moving erratically in the vehicle width direction, and

changes the determination standard so that it is more difficult to determine that the other vehicle will change lanes when the time for which it is determined that the other vehicle is moving erratically in the vehicle width direction is long than when the time for which it is determined that the other vehicle is moving erratically in the vehicle width direction is short.

According to this embodiment, excessive deceleration control in the self-vehicle with respect to what is clearly erratic movement in the other vehicle can be suppressed.

9. In the control device (e.g., 2) according to the foregoing embodiment,

the determining unit (e.g., 20):

changes the determination standard so that it is easier to determine that the other vehicle (e.g., V2) will change lanes when the time for which it is determined that the other vehicle is moving erratically in the vehicle width direction is short than when it is determined that the other vehicle is not moving erratically in the vehicle width direction, and

changes the determination standard so that it is more difficult to determine that the other vehicle will change lanes when the time for which it is determined that the other vehicle is moving erratically in the vehicle width direction is long than when it is determined that the other vehicle is not moving erratically in the vehicle width direction.

According to this embodiment, excessive deceleration control in the self-vehicle with respect to what is clearly erratic movement in the other vehicle can be suppressed.

10. In the control device (e.g., 2) according to the foregoing embodiment,

the determining unit (e.g., 20) changes the determination standard so that it is easier to determine that the other vehicle (e.g., V2) will change lanes when an extent to which the other vehicle is moving erratically in the vehicle width direction is greater than a threshold.

According to this embodiment, deceleration control that causes the self-vehicle to decelerate can be performed with respect to another vehicle for which the extent of erratic movement is high.

11. A vehicle (e.g., 1) according to the foregoing embodiment includes:

a recognizing unit (e.g., 41, 42, 43) that recognizes another vehicle (e.g., V2) present in an adjacent lane (e.g., L₂) adjacent to a travel lane (e.g., L₁) in which a self-vehicle (e.g., 1) travels;

a determining unit (e.g., 20) that, on the basis of behavior of the other vehicle recognized by the recognizing unit and a determination standard set with respect to the behavior, determines whether or not the other vehicle will change lanes into the travel lane of the self-vehicle; and

a controller (e.g., 20) that, in accordance with a result of the determination by the determining unit as to whether or not the other vehicle will change lanes, controls travel of the self-vehicle,

wherein the determining unit changes the determination standard in accordance with a distance (e.g., DT) between the self-vehicle and the other vehicle in a travel direction of the self-vehicle.

According to this embodiment, mistaken determinations (that the other vehicle will change lanes) with respect to erratic movement of the other vehicle can be suppressed, and the determination that the other vehicle will change lanes can be made appropriately in accordance with the distance between the self-vehicle and the other vehicle.

The invention is not limited to the foregoing embodiments, and various variations/changes are possible within the spirit of the invention.

What is claimed is:

1. A control device that controls travel of a vehicle, the control device comprising:
a recognizing unit that recognizes another vehicle present in an adjacent lane adjacent to a travel lane in which a self-vehicle travels;
a determining unit that, on the basis of behavior of the other vehicle recognized by the recognizing unit and a determination standard set with respect to the behavior, determines whether or not the other vehicle will change lanes into the travel lane of the self-vehicle; and
a controller that, in accordance with a result of the determination by the determining unit as to whether or not the other vehicle will change lanes, controls travel of the self-vehicle,
wherein the determining unit changes the determination standard in accordance with a distance between the self-vehicle and the other vehicle in a travel direction of the self-vehicle.

2. The control device according to claim 1,
wherein when the distance is greater than or equal to a predetermined distance, the determining unit determines that the other vehicle will change lanes at a point in time when at least part of the other vehicle has crossed a line, of lines defining the travel lane, which is located on the adjacent lane side, and when the distance is less than the predetermined distance, the determining unit changes the determination standard so as to determine that the other vehicle will change lanes at a point in time when at least part of the other vehicle crosses a virtual line set within the adjacent lane.

3. The control device according to claim 1, further comprising:
an obtaining unit that obtains a travel speed of the self-vehicle,
wherein the determining unit:
changes the determination standard in accordance with the travel speed of the self-vehicle obtained by the obtaining unit, and
changes the determination standard so that it is easier to determine that the other vehicle will change lanes when the travel speed of the self-vehicle is high than when the travel speed of the self-vehicle is low.

4. The control device according to claim 1,
wherein when the determining unit has determined that the other vehicle will change lanes, the controller performs deceleration control that causes the self-vehicle to decelerate.

5. The control device according to claim 4,
wherein the recognizing unit recognizes a forward vehicle present in front in the travel lane in which the self-vehicle travels, and
the controller changes the extent to which the self-vehicle is caused to decelerate in the deceleration control in accordance with whether or not the forward vehicle has been recognized by the recognizing unit.

6. The control device according to claim 5,
wherein the controller sets the extent to which the self-vehicle is caused to decelerate in the deceleration control to zero when the forward vehicle is not recognized by the recognizing unit.

7. The control device according to claim 1,
wherein the determining unit:
determines whether or not the other vehicle is moving erratically in a vehicle width direction on the basis of the behavior of the other vehicle, and
changes the determination standard so that it is more difficult to determine that the other vehicle will change lanes when it is determined that the other vehicle is moving erratically in the vehicle width direction than when it is determined that the other vehicle is not moving erratically in the vehicle width direction.

8. The control device according to claim 7,
wherein the determining unit:
changes the determination standard in accordance with a time for which it is determined that the other vehicle is moving erratically in the vehicle width direction, and
changes the determination standard so that it is more difficult to determine that the other vehicle will change lanes when the time for which it is determined that the other vehicle is moving erratically in the vehicle width direction is long than when the time for which it is determined that the other vehicle is moving erratically in the vehicle width direction is short.

9. The control device according to claim 8,
wherein the determining unit:
changes the determination standard so that it is easier to determine that the other vehicle will change lanes when the time for which it is determined that the other vehicle is moving erratically in the vehicle width direction is short than when it is determined that the other vehicle is not moving erratically in the vehicle width direction, and
changes the determination standard so that it is more difficult to determine that the other vehicle will change lanes when the time for which it is determined that the other vehicle is moving erratically in the vehicle width direction is long than when it is determined that the other vehicle is not moving erratically in the vehicle width direction.

10. The control device according to claim 7,
wherein the determining unit changes the determination standard so that it is easier to determine that the other vehicle will change lanes when an extent to which the other vehicle is moving erratically in the vehicle width direction is greater than a threshold.

11. A vehicle comprising:
a recognizing unit that recognizes another vehicle present in an adjacent lane adjacent to a travel lane in which a self-vehicle travels;
a determining unit that, on the basis of behavior of the other vehicle recognized by the recognizing unit and a determination standard set with respect to the behavior, determines whether or not the other vehicle will change lanes into the travel lane of the self-vehicle; and
a controller that, in accordance with a result of the determination by the determining unit as to whether or not the other vehicle will change lanes, controls travel of the self-vehicle,
wherein the determining unit changes the determination standard in accordance with a distance between the self-vehicle and the other vehicle in a travel direction of the self-vehicle.
